(19) United States
(12) Patent Application Publication
(10) Pub. No.: US 2010/0315567 A1
(43) Pub. Date: Dec. 16, 2010

(54) LIQUID CRYSTAL BASED BROADBAND FILTER FOR FAST POLARIZATION IMAGING

(76) Inventors: Bing Wen, Thousand Oaks, CA (US); Donald Taber, Newbury Park, CA (US); Dong-Feng Gu, Thousand Oaks, CA (US)

Correspondence Address: KOPPEL, PATRICK ,HEYBL & DAWSON, PLC, 2815 TOWNSGATE ROAD, SUITE 215, WESTLAKE VILLAGE, CA, 91361-5827, US

(21) Appl. No.: 12/484,849

(22) Filed: Jun. 15, 2009

(51) Int. Cl. G02F 1/1335; G01J 4/00

(52) U.S. Cl. 349/18; 356/365

(57) ABSTRACT

A liquid crystal based broadband filter and imaging system for analyzing the polarization state of radiation. The filter includes four elements: a quarter wave plate; a 45° polarization rotator; a 90° polarization rotator; and a fixed polarizer. The first three of these elements are electronically switchable, allowing the user to select from any of the six possible polarization states. The switchable elements use multiple liquid crystal cells made from dual-frequency materials. A dual-frequency signal is used to activate and deactivate the various elements to achieve the desired state configuration. The dual-frequency signal drives the liquid crystal cells in and out of states, improving the overall switching time of the filter. The configuration of the liquid crystal cells within each of the filter allows broadband operation over most of the visible, infrared and ultraviolet spectra. The filter cycles through six configurations corresponding to the six polarization states of the incident radiation. Thus, the polarization state of the radiation can be completely characterized using the four Stokes parameters. Information related to the intensity and polarization of the radiation can be stored, displayed and analyzed.

### BACKGROUND OF THE INVENTION

1. Field of the Invention

The present invention as embodied in the claims relates to polarization imaging devices and, more particularly, to such devices using liquid crystal filters.

2. Description of the Related Art

Polarization is a property of electromagnetic radiation which describes the relative orientation of the field components in a plane perpendicular to the propagation direction of the electromagnetic wave. The polarization state of a wave may be conveniently described mathematically using the Stokes parameters. The Stokes parameters are commonly abbreviated as I, Q, U, and V. The I parameter represents the intensity of the wave with Q, U, and V representing the various states of the polarization, where Q represents 90 and 180 degree linear polarization; U represents 45 and 135 degree polarization; and V represents right-hand or left-hand polarization.

A multi-stage combination of polarizers and waveplates are often used to analyze the complete polarization state of incident radiation. The various state components (i.e. Q, U and V) may be determined one at a time with an analyzer. An analyzer measures the radiation that passes through the multi-stage system at a given configuration. The system is configured to pass a certain component of the incident beam which is measured by the analyzer. Then the polarizer elements are reconfigured, and a different component of the incident beam is measured. Once all the components have been measured, including the intensity, the complete polarization state of the radiation is known.

One way to reconfigure the system to transmit the various components of the beam is to mechanically rotate or swap one or more stages of the system between measurements. This mechanical switching process is relatively slow (200-500 ms) and involves moving parts which can cause vibrations and consume power. Another way to reconfigure the system between measurements is to electrically switch the stages of the system. Some systems have utilized switchable liquid crystal stages; however, these devices have narrow spectrum ranges (<5%), low contrast ratios, and, although faster than the mechanically switched devices, are still relatively slow (10-100 ms).

### SUMMARY OF THE INVENTION

One embodiment of an optical filter according to the present invention comprises the following elements. An electronically switchable quarter wave plate is arranged along a longitudinal axis. An electronically switchable 45° polarization rotator is arranged along the longitudinal axis. An electronically switchable 90° polarization rotator is arranged along the longitudinal axis. A fixed polarizer is aligned at 0° or 90° and arranged along the longitudinal axis.

One embodiment of an imaging system according to the present invention comprises the following elements. A broadband optical filter is configured to operate in at least six polarizing states. The optical filter includes: a liquid crystal based quarter wave plate that is electronically switchable between at least two states; a liquid crystal based 45° polarization rotator that is electronically switchable between at least two states; a liquid crystal based 90° polarization rotator that is electronically switchable between at least two states; and a fixed polarizer. An image input device is arranged to interact with incident light that is transmitted through the optical filter. An image output device is connected to manage data from the image input device. A control system is connected to electronically switch the optical filter between the at least six polarization states.

One method of analyzing light according to the present invention comprises the following. Light is passed through a polarizing optical filter having four stages. A voltage is selectively applied to one or more of the stages to deactivate the polarization effect of the one or more stages. The optical filter is switched from one of at least six polarization states to another of the polarization states in approximately 1 millisecond (ms). The polarization states are cycled through. A portion of the light that passes through said optical filter is collected at an image input device.

Another embodiment of an optical filter according to the present invention comprises the following elements. An electronically switchable 45° polarization rotator is arranged along a longitudinal axis. An electronically switchable 90° polarization rotator is arranged along the longitudinal axis. A fixed polarizer is aligned at 0° or 90° and arranged along said longitudinal axis.

### BRIEF DESCRIPTION OF THE DRAWINGS

FIG. 1 is a perspective view of an optical filter according to an embodiment of the present invention.

FIG. 2 is a cross-sectional view of an electronically switchable quarter wave plate according to an embodiment of the present invention.

FIG. 3 is a cross-sectional view of an electronically switchable 45° polarization rotator according to an embodiment of the present invention.

FIG. 4 is a cross-sectional view of an electronically switchable 90° polarization rotator according to an embodiment of the present invention.

FIG. 5 shows three cross-sectional views of a liquid crystal cell with no applied signal, a low frequency signal, and a high frequency signal, respectively, according to an embodiment of the present invention.

FIG. 6 is block diagram of an imaging system according to an embodiment of the present invention.

FIG. 7 is a perspective view of an optical filter according to an embodiment of the present invention.

### DETAILED DESCRIPTION OF THE INVENTION

Embodiments of the present invention provide a system having an improved liquid crystal based broadband filter for fast polarization imaging. One embodiment of the system comprises four stages: three polarization elements and an analyzer. The three polarization elements are electronically switchable, enabling the system to selectively transmit only that fraction of the incident light polarized in one of six polarization states: linearly polarized at 0°, 45°, 90° or 135°, or circularly polarized in a right- or left-handed sense. In another embodiment, the system only comprises the two electronically switchable elements that linearly polarize the light. In these embodiments, each of the polarization elements comprises a stack of multiple liquid crystal cells aligned at various angular orientations. Using a dual-frequency electrical driving signal, the system is capable of switching between states in approximately 1 ms. Each stage is aligned at a particular angle such that the system transmits 75-100% of the center wavelength. For such devices, it is useful to define a contrast ratio as the ratio of the intensity of light in the selected polarization to that in other polarizations which leaks through the activated device when the incident light is randomly polarized. Embodiments of the system disclosed herein yield a contrast ratio of 100:1 and operates with a wide field of regard (≧20°).

Embodiments of the invention are described herein with reference to schematic illustrations of idealized embodiments of the invention. As such, variations from the shapes of the illustrations as a result, for example, of manufacturing and/or mounting techniques are expected. Embodiments of the invention should not be construed as limited to the particular shapes of the elements illustrated herein but are to include deviations in shapes that result, for example, from manufacturing. Thus, the elements illustrated in the figures are schematic in nature; their shapes are not intended to illustrate the precise shape of the element and are not intended to limit the scope of the invention. The elements are not drawn to scale relative to each other but, rather, are shown generally to convey spatial and functional relationships.

The term “light” as used herein is not limited to electromagnetic radiation within the visible spectrum. For convenience, “light” may also include portions of the electromagnetic spectrum outside the visible spectrum, such as the infrared or ultraviolet spectra, for example.

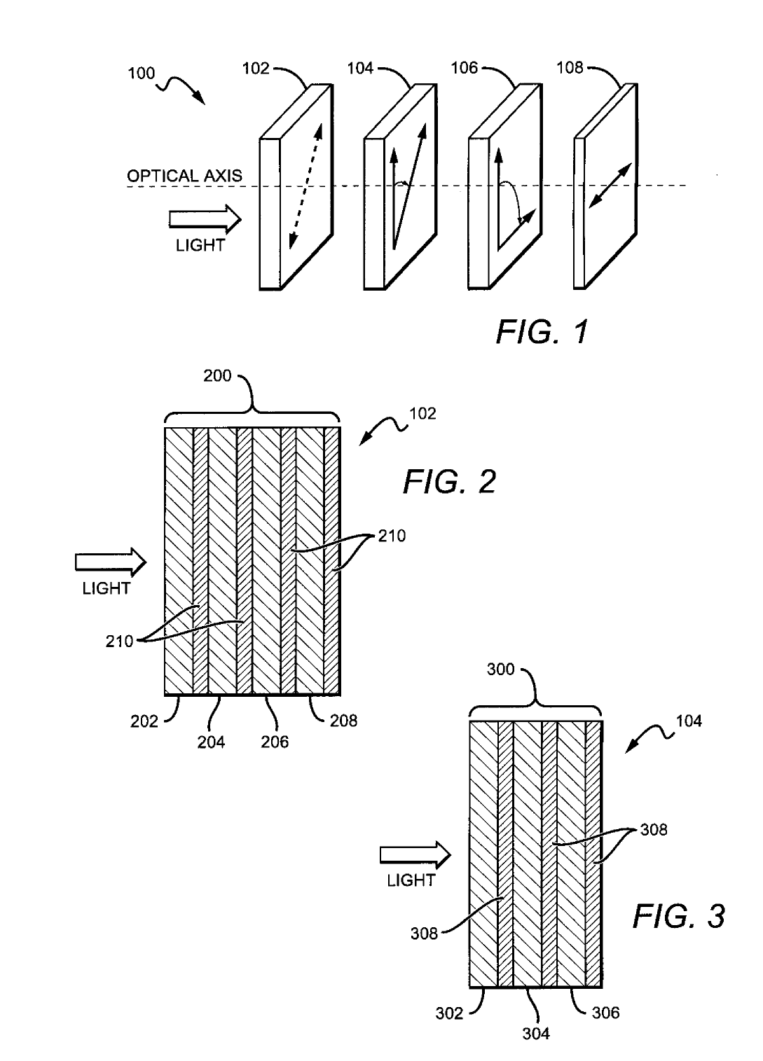

FIG. 1 is a simplified perspective view of an optical filter 100 according to an embodiment of the present invention. The filter comprises four optical elements aligned along a longitudinal optical axis. The optical elements are: a switchable quarter wave plate 102; a switchable 45° polarization rotator 104; a switchable 90° polarization rotator 106; and a fixed polarizer 108. The quarter wave plate 102 and the polarization rotators 104, 106 are electronically switchable between states that, alternatively, transmit and block light having a particular polarization state. In combination, the four elements can be configured to selectively pass light having each of the six polarization states. The optical filter can be used in combination with an image input device (not shown in FIG. 1) to completely characterize the polarization state of an incident beam of light.

The optical elements 102, 104, 106, 108 can be arranged in various permutations. One suitable arrangement is described below. In this particular embodiment the incoming light is first incident on the switchable quarter wave plate 102. A portion of the light is transmitted depending on the polarization state of the light and whether the quarter wave plate 102 is switched on or off as explained in more detail below. The light is then passed to the switchable 45° polarization rotator 104, then to the 90° polarization rotator 106, and finally to the fixed polarizer 108. The light that is passed to the fixed polarizer 108 is filtered according to the state of the previous elements (i.e., according to the state of their respective switches).

The switchable quarter wave plate 102 comprises a stack 200 of four liquid crystal cells (LCCs) as shown in FIG. 2. Each of the cells is characterized by its principal axis and retardation for a specific wavelength (λ). All the angles discussed herein have a tolerance of approximately ±1°. In this particular embodiment, the LCCs are arranged as follows. The first LCC 202 has a thickness characterized by half-wavelength (λ/2) retardation with a principal axis oriented along an angle of 15°. The second LCC 204 has a thickness characterized by λ/4 retardation with a principal axis oriented along an angle of 75°. The third LCC 206 has a thickness characterized by λ/4 retardation with a principal axis oriented along an angle of 30°. The fourth LCC 208 has a thickness characterized by λ/2 retardation with a principal axis oriented along an angle of −30°. This information is summarized in the Table 1 below.

TABLE 1
Switchable Quarter Wave Plate

| LCC | Retardation | Orientation |
|---|---|---|
| 1^{st} | λ/2 | 15° |
| 2^{nd} | λ/4 | 75° |
| 3^{rd} | λ/4 | 30° |
| 4^{th} | λ/2 | −30° |

An applied voltage signal switches the alignment of the LCCs 202, 204, 206, 208 between a planar state (LC molecules parallel to the cell surface) and a homoetropic state (LC molecules vertical to the cell surface). At the parallel alignment, each LCC functions as a wave plate with retardation along the specified angles. At the vertical alignment, there is no effect on the transmitted light. Thus, the LCCs 202, 204, 206, 208 collectively function as a broadband quarter wave plate.

Each of the LCCs 202, 204, 206, 208 is associated with a compensator plate. In this particular embodiment, compensator plates 210 are disposed adjacent to each of the LCCs on the back sides relative to the incident light. Alternatively, the compensator plates 210 can also be disposed on the front sides of the LCCs so long as they remain adjacent to the LCCs.

The compensator plates 210 improve the contrast ratio at the vertical state of each LCC and widen the field of regard. When a voltage is applied to the LCCs to orient them in the vertical state, at the cell surface there is a transition layer with finite thickness (depending on the voltage value, usually tens of nanometers) in which the LC molecule transitions from a parallel orientation relative to the cell surface to a vertical orientation. This happens because the finite electric field cannot completely overcome the original boundary condition near the cell surface. The residue retardation due to the existence of this boundary layer is typically small (on the order of 20 nm optical path difference for orthogonal polarizations), but can cause light leakage. This leakage can be reduced or canceled with a compensator plate. The compensator plates 210 may be made from various uniaxially birefringent materials (with one suitable material being a polymerized liquid crystal film) aligned so that their optic axes are within the LCC surface plane and oriented perpendicular to the rubbing directions of the adjacent individual LCCs.

The light that is transmitted through the switchable quarter wave plate 102 is then incident on the next element in the system. According to the configuration shown in FIG. 1, the next element is a switchable 45° polarization rotator 104 as shown in FIG. 3. The rotator 104 comprises a stack 300 of LCCs. In this embodiment, the LCC stack 300 is arranged as follows. The first LCC 302 has a thickness characterized by half-wavelength (λ/2) retardation with a principal axis oriented along an angle of 6.5°. The second LCC 304 has a thickness characterized by half-wavelength (λ/2) retardation with a principal axis oriented along an angle of 22.5°. The third LCC 306 has a thickness characterized by half-wavelength (λ/2) retardation with a principal axis oriented along an angle of 38.5°. All the angles discussed herein have a tolerance of approximately ÷1°. This information is summarized in Table 2 below.

TABLE 2
45° Polarization Rotator Stack

| LCC | Retardation | Orientation |
|---|---|---|
| 1^{st} | λ/2 | 6.5° |
| 2^{nd} | λ/2 | 22.5° |
| 3^{rd} | λ/2 | 38.5° |

The first and third LCCs function to expand the range of wavelengths that the 45° polarization rotator 104 can accept. In other embodiments, additional LCCs with different orientation angles can be added to the stack to further expand the broadband capability of the system.

The 45° polarization rotator 104 is controlled with an electric signal. When a first signal is applied, the LCCs 302, 304, 306 are aligned parallel, and the polarization rotator 104 rotates the incident radiation by 45°. When a second signal is applied, the LCCs 302, 304, 306 are aligned vertical, and the incident radiation is not rotated.

Each of the LCCs in the rotator 104 is associated with a compensator plate 308. The compensator plates 308 may be adjacent to the front sides or the back sides of the LCCs 302, 304, 306 relative to the light (compensator plates 308 shown adjacent to the back sides in FIG. 3).

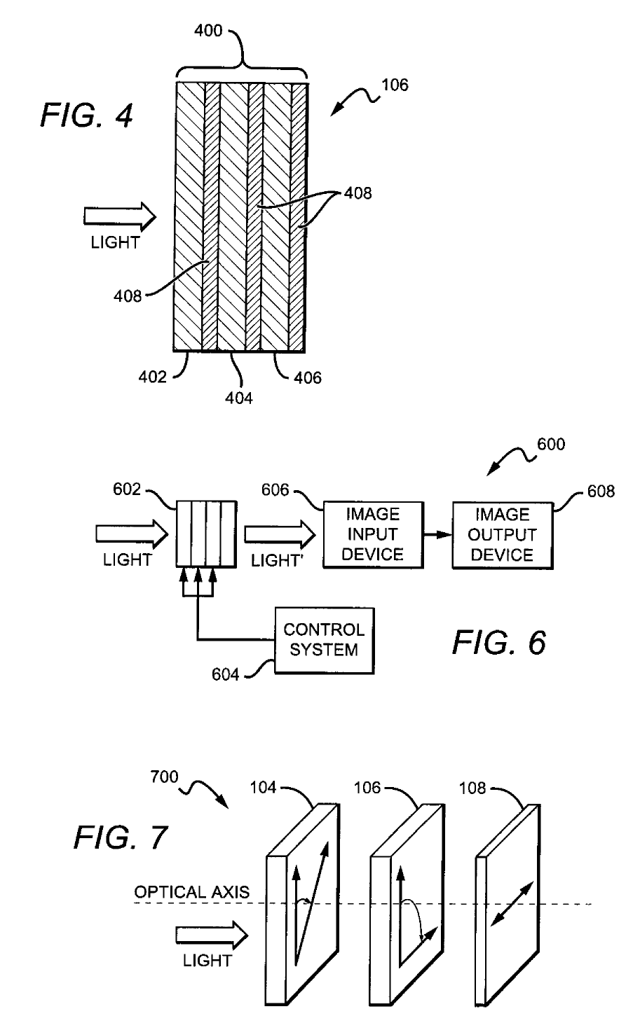

After interacting with the polarization rotator 104, transmitted light is then incident on the next element which, in the configuration shown in FIG. 1, is the 90° polarization rotator 106. FIG. 4 shows an embodiment of an electronically switchable 90° polarization rotator 106. The 90° rotator 106 comprises a stack 400 of three LCCs which, in this embodiment, are arranged as follows. The first LCC has a retardation of λ/2 and an orientation of 14°. The second LCC has a retardation of λ/2 and a retardation of 45°. The third LCC has a retardation of λ/2 and an orientation of 76°. All the angles discussed herein have a tolerance of approximately ±1°. This information is summarized in Table 3 below.

TABLE 3
90° Polarization Rotator Stack

| LCC | Retardation | Orientation |
|---|---|---|
| 1^{st} | λ/2 | 14° |
| 2^{nd} | λ/2 | 45° |
| 3^{rd} | λ/2 | 76° |

Similarly as the 45° polarization rotator 104, the 90° polarization rotator 106 is a broadband element. When the LCCs 402, 404, 406 are at parallel alignment, each functions as a half wave plate along a specific orientation. Together the LCCs 402, 404, 406 are capable of interacting with a relatively broad range of wavelengths.

As with the quarter wave plate 104 and 45° rotator 106, the 90° polarization rotator is switchable between parallel alignment and vertical alignment using an electric signal. When a first signal is input to the LCC stack 400, the LCCs 402, 404, 406 align parallel and the polarization of the transmitted light is rotated by 90°. When a second signal is applied to the stack 400, the LCCs 402, 404, 406 are aligned vertical, and the polarization of the transmitted light is unaffected.

Each LCC in the stack 400 is associated with a compensator plate 408. The compensator plates may be adjacent to the front sides or the back sides of the LCCs relative to the incident light. The compensator plates 408 are shown adjacent to the back sides of the LCCs 402, 404, 406.

In the configuration shown in FIG. 1, light that is transmitted through the 90° polarization rotator 106 is then incident a fixed polarizer 108, sometimes referred to as an analyzer. The fixed polarizer 108 may be aligned at 0° or 90°. In one embodiment, the fixed polarizer comprises a wire grid polarizer. This kind of polarizer is regular array of fine metallic wires, placed in a plane perpendicular to the incident radiation. Incident waves having an electric field component that is perpendicular to the wires (i.e., having a certain polarization) pass through the wire grid, substantially unaffected. For waves having an electric field parallel to the wires, the wave is reflected. Other types of fixed polarizers may also be used.

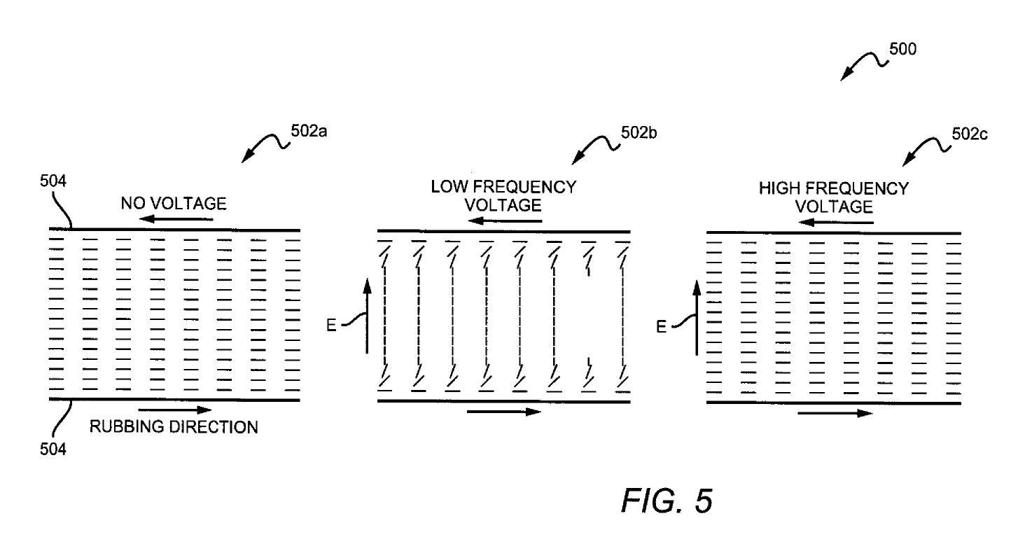

As stated above, the quarter wave plate 102, the 45° polarization rotator 104, and the 90° polarization rotator 106 can all be made from liquid crystal materials that are responsive to a dual-frequency voltage signal. FIG. 5 illustrates a cross-sectional representation of a dual-frequency material between two glass substrates, a nematic liquid crystal cell (LCC) 502. A pair of opposing alignment layers 504 are disposed opposite each other with one of the layers 504 rotated 180 degrees so that the alignment directions of the two layers 504 are anti-parallel to each other. With no voltage signal applied, the liquid crystal molecules between the two layers 504 align themselves in a uniform fashion, although slightly tilted with a small angle with respect to the cell surface (pre-tilt).

The liquid crystal molecules designed for the dual frequency nematic LCCs have longitudinal dipole moments at frequencies lower than certain value. In response to low frequency electric fields, these dipoles align their long axes parallel to the direction of the electric field (E). Therefore, an applied low frequency voltage above a certain threshold voltage will cause the molecules to align as shown in LCC 502b. However, a different effect is observed when a high frequency voltage signal is applied. Because the molecules do not have time to react to the changing field conditions along their long axes at a high frequency, the transverse dipole moments in the molecules become dominant and cause the molecules to align horizontally with respect to the cell surfaces as shown in LCC 502c. The different behavior of the molecules relative to the frequency is used to speed up the transition between molecular alignments (i.e. polarization states).

In this particular embodiment, the LCC 502 functions as a polarization rotator when there is no applied signal as shown by LCC 502a. The rotating effect is turned off with a low frequency applied voltage and light is freely transmitted as shown in LCC 502b. If the low frequency voltage is removed the molecules will eventually return to their relaxed twisted state. However, this process follows a time constant and can be too slow for some applications. In order to facilitate the relaxing transition, a high frequency voltage can then be applied to push the molecules back to their twisted state as shown in LCC 502c. In this manner and according to the embodiment shown in FIG. 1, the switching speed of the LCCs that comprise the various elements is reduced to times on the order of a 1 ms.

FIG. 6 illustrates a block diagram of an embodiment of an imaging system 600 according to the present invention. Radiation (e.g., LIGHT) is incident on the optical filter 602. During a given period, radiation having a particular polarization passes through the optical filter 602 according to the selected configuration of the elements within the filter (shown in more detail in FIG. 1). The optical filter is controlled by a control system 604 connected to allow the user to select between configurations that correspond to the six available polarization states. The control system 604 selects the configuration by switching the three switchable elements 102, 104, 106 with the dual-frequency control signal. This switching process can be initiated manually or automatically, cycling through the various states at high speed. The selected configuration determines the polarization state of the transmitted radiation.

The transmitted radiation (e.g., LIGHT′) is detected at an image input device 606. The image input device 606 may comprise a photodetector, an array of photodetectors, a charge coupling device (CCD), or any other pixilated device capable of transducing optical energy to electrical signals for producing an image. The image input device 606 generates an output signal that carries information relating to the intensity of the radiation at the image input device 606. The image input device 606 transmits or temporarily stores intensity information for each of the polarization states of the radiation that is being measured. With this information the polarization state of the incident light can be completely characterized using the four Stokes parameters.

Information from the image input device 606 can be passed along to the image output device 608. The image output device can be chosen depending on the application for which the system is designed. The image output device 608 can be a database or another electronic storage device where the information can be processed and analyzed. This may be beneficial with applications such as medical diagnosis of tissue or non-destructive defect evaluation of mechanical structures. The image output device can also be a visual display where the information can be displayed in real time and analyzed almost immediately. Real time polarization imaging may be useful in applications such as search and rescue and target identification and acquisition.

In some applications, it is only necessary to measure the linear polarization state of the incoming light. In this case, the quarter wave plate element used for measuring the circular polarization would not be needed. FIG. 7 is a simplified perspective view of an embodiment of an optical filter 700 used to measure the linear polarization state of incident light. The filter 700 comprises three optical elements aligned along a longitudinal optical axis. The optical elements are: a switchable 45° polarization rotator 104; a switchable 90° polarization rotator 106; and a fixed polarizer 108. The polarization rotators 104, 106 are electronically switchable between states that, alternatively, transmit and block light having a particular linear polarization state. In combination, the three elements can be configured to selectively pass light having each of the tour linear polarization states. The optical filter 700 can be used in combination with an image input device (not shown in FIG. 7) to completely characterize the linear polarization state of an incident beam of light.

The optical elements 104, 106, 108 can be arranged in various permutations. One suitable arrangement is described above with reference to the optical filter 100 shown in FIG. 1; however, in optical filter 700 the quarter wave plate 102 is removed as information about the circular polarization is not needed. The optical filter 700 shows an embodiment wherein the quarter wave plate is prevented from interacting with the incident light. Thus, the quarter wave plate may be physically removed from the light path (as shown in FIG. 7), or it may be configured to function as a transparent element that does not substantially affect transmitted light. The optical filter 700 functions similarly as the optical filter 100 with the difference being that optical filter 700 is only configured to measure the linear polarization of light.

The elements 104, 106 in optical filter 700 both comprise stacks of liquid crystal cells configured identically in this embodiment as those discussed above with reference to optical filter 100 (i.e., the angular orientation and retardation are the same).

Although the present invention has been described in detail with reference to certain suitable configurations thereof, other versions are possible. Therefore, the spirit and scope of the invention should not be limited to the versions described above.

We claim:

1. An optical filter, comprising:
an electronically switchable quarter wave plate arranged along a longitudinal axis;
an electronically switchable 45° polarization rotator arranged along said longitudinal axis;
an electronically switchable 90° polarization rotator arranged along said longitudinal axis; and
a fixed polarizer aligned at 0° or 90° and arranged along said longitudinal axis.

2. The optical filter of claim 1, wherein said quarter wave plate, said 45° polarization rotator and said 90° polarization rotator each comprise a respective stack of liquid crystal cells.

3. The optical filter of claim 2, wherein each of said liquid crystal cells is associated with a compensator plate.

4. The optical filter of claim 2, each of said liquid crystal cells comprising a dual-frequency liquid crystal material.

5. The optical filter of claim 1, wherein incident light interacts first with said quarter wave plate, second with said 45° polarization rotator, third with said 90° polarization rotator, and finally with said fixed polarizer.

6. The optical filter of claim 5, said quarter wave plate comprising:
a first cell having a retardation of a half wavelength and an orientation of approximately 15°;
a second cell having a retardation of a quarter wavelength and an orientation of approximately 75°;
a third cell having a retardation of a quarter wavelength and an orientation of approximately 30°; and
a fourth cell having a retardation of a half wavelength and an orientation of approximately −30°.

7. The optical filter of claim 5, said 45° polarization rotator comprising:
a first cell having a retardation of a half wavelength and an orientation of approximately 6.5°;
a second cell having a retardation of a half wavelength and an orientation of approximately 22.5°; and
a third cell having a retardation of a half wavelength and an orientation of approximately 38.5°.

8. The optical filter of claim 5, said 90° polarization rotator comprising:
a first cell having a retardation of a half wavelength and an orientation of approximately 14°;
a second cell having a retardation of a half wavelength and an orientation of approximately 45°; and
a third cell having a retardation of a half wavelength and an orientation of approximately 76°.

9. The optical filter of claim 1, wherein said optical filter is electronically switchable between all six polarization states of incident light.

10. The optical filter of claim 1, wherein said optical filter has a switching speed of approximately 1 millisecond (ms).

11. The optical filter of claim 1, wherein said optical filter is arranged to polarize substantially all wavelengths of radiation in the visible spectrum.

12. The optical filter of claim 1, said fixed polarizer comprising a wire grid polarizer.

13. An imaging system, comprising:
a broadband optical filter that is configured to operate in at least six polarizing states, said optical filter comprising:
a liquid crystal based quarter wave plate that is electronically switchable between at least two states;
a liquid crystal based 45° polarization rotator that is electronically switchable between at least two states;
a liquid crystal based 90° polarization rotator that is electronically switchable between at least two states; and
a fixed polarizer;
an image input device arranged to interact with incident light that is transmitted through said optical filter;
an image output device connected to manage data from said image input device; and
a control system connected to electronically switch said optical filter between said at least six polarization states.

14. The imaging system of claim 13, said quarter wave plate, said 45° polarization rotator and said 90° polarization rotator each comprising a respective stack of multiple liquid crystal cells.

15. The imaging system of claim 14, wherein each of said liquid crystal cells is associated with a compensator plate.

16. The imaging system of claim 14, wherein said control system switches said liquid crystal cells with a dual-frequency signal.

17. The imaging system of claim 14, wherein incident light interacts first with said quarter wave plate, second with said 45° polarization rotator, third with said 90° polarization rotator, and finally with said fixed polarizer.

18. The imaging system of claim 17, said quarter wave plate stack comprising:
a first cell having a retardation of a half wavelength and an orientation of approximately 15°;
a second cell having a retardation of a quarter wavelength and an orientation of approximately 75°;
a third cell having a retardation of a quarter wavelength and an orientation of approximately 30°; and
a fourth cell having a retardation of a half wavelength and an orientation of approximately −30°.

19. The imaging system of claim 17, said 45° polarization rotator stack comprising:
a first cell having a retardation of a half wavelength and an orientation of approximately 6.5°;
a second cell having a retardation of a half wavelength and an orientation of approximately 22.5°; and
a third cell having a retardation of a half wavelength and an orientation of approximately 38.5°.

20. The imaging system of claim 17, said 90° polarization rotator stack comprising:
a first cell having a retardation of a half wavelength and an orientation of approximately 14°;
a second cell having a retardation of a half wavelength and an orientation of approximately 45°; and
a third cell having a retardation of a half wavelength and an orientation of approximately 76°.

21. The imaging system of claim 13, wherein said optical filter has a switching speed of approximately 1 millisecond (ms).

22. The imaging system of claim 13, wherein said output device displays an image related to said data.

23. The imaging system of claim 13, wherein said output devices stores said data.

24. The imaging system of claim 13, wherein said optical filter is configured to operate with a contrast ratio of approximately 100:1.

25. A method of analyzing light, comprising:
passing light through a polarizing optical filter having four stages;
selectively applying a voltage to one or more of said stages to deactivate the polarization effect of said one or more stages;
switching said optical filter from one of at least six polarization states to another of said polarization states in approximately 1 millisecond (ms);
cycling through said polarization states; and
collecting a portion of the light that passes through said optical filter at an image input device.

26. The method of claim 25, further comprising analyzing the light that passes through said optical filter during said polarization states such that the light can be completely characterized by the Stokes parameters.

27. The method of claim 25, driving said stages with a dual-frequency signal.

28. An optical filter, comprising:
an electronically switchable 45° polarization rotator arranged along a longitudinal axis;
an electronically switchable 90° polarization rotator arranged along said longitudinal axis; and
a fixed polarizer aligned at 0° or 90° and arranged along said longitudinal axis.

29. The optical filter of claim 28, wherein said 45° polarization rotator and said 90° polarization rotator each comprise a respective stack of liquid crystal cells.

30. The optical filter of claim 29, wherein each of said liquid crystal cells is associated with a compensator plate.

31. The optical filter of claim 29, each of said liquid crystal cells comprising a dual-frequency liquid crystal material.

32. The optical filter of claim 28, wherein incident light interacts first with said 45° polarization rotator, second with said 90° polarization rotator, and finally with said fixed polarizer.

33. The optical filter of claim 32, said 45° polarization rotator comprising:
a first cell having a retardation of a half wavelength and an orientation of approximately 6.5°;
a second cell having a retardation of a half wavelength and an orientation of approximately 22.5°; and
a third cell having a retardation of a half wavelength and an orientation of approximately 38.5°.

34. The optical filter of claim 32, said 90° polarization rotator comprising:
a first cell having a retardation of a half wavelength and an orientation of approximately 14°;
a second cell having a retardation of a half wavelength and an orientation of approximately 45°; and
a third cell having a retardation of a half wavelength and an orientation of approximately 76°.

35. The optical filter of claim 28, wherein said optical filter is electronically switchable between all four linear polarization states of incident light.

36. The optical filter of claim 28, wherein said optical filter has a switching speed of approximately 1 millisecond (ms).

37. The optical filter of claim 28, wherein said optical filter is arranged to polarize substantially all wavelengths of radiation in the visible spectrum.

38. The optical filter of claim 28, said fixed polarizer comprising a wire grid polarizer.
